(19) United States
(12) Patent Application Publication
(10) Pub. No.: US 2011/0134035 A1
(43) Pub. Date: Jun. 9, 2011

(54) Transmitting Apparatus, Display Apparatus, and Remote Signal Input System

(75) Inventors: Kee Tae Um, Seoul (KR); Kyu Tae Lee, Seoul (KR)

(73) Assignee: LG INNOTEK CO., LTD., Seoul (KR)

(21) Appl. No.: 13/056,885

(22) PCT Filed: Aug. 3, 2009
(86) PCT No.: PCT/KR2009/004328

§ 371 Date: Jan. 31, 2011

(30) Foreign Application Priority Data
Aug. 6, 2008 (KR) 10-2008-0077134

(51) Int. Cl. G06F 3/033; H04B 10/00

(52) U.S. Cl. 345/158; 398/106

(57) ABSTRACT

Disclosed is a remote signal input system. The remote signal input system comprises a transmitting device for generating signal light and a display panel comprising a plurality of sensors for sensing the signal light. Location signals are input into a display device having the display panel by using the signal light generated from the transmitting device.

### TECHNICAL FIELD

The embodiment relates to a transmitting device, a display device and a remote signal input system.

### BACKGROUND

With the development of information processing technologies, a graphic user interface technique is developed, so that a user can directly input signals into a screen that displays an image.

### BRIEF SUMMARY

An embodiment provides a remote signal input system capable enabling a user to input signals to a screen of a display device at a position far from the screen of the display device. An embodiment also provides a transmitting device and a display device included in the remote signal input system.

According to an embodiment, there is provided a remote signal input system comprising a transmitting device for generating signal light; and a display panel comprising a plurality of sensors for sensing the signal light.

According to an embodiment, there is provided a display device comprising a display panel having a plurality of sensors for sensing signal light generated from a transmitting device; and a detection unit that receives sensing signals output from the sensors to detect signals transmitted from the transmitting device.

According to an embodiment, there is provided a transmitting device comprising a light source for generating signal light; and a driving unit that drives the light source to generate the signal light.

The signal light generated from the transmitting device of an embodiment is irradiated onto a predetermined area of the display panel. At this time, sensors of the display panel, which are positioned corresponding to the predetermined area, detect electric signals based on the signal light, so that the display device of the embodiment can detect the location of the signal light input into the display device.

Therefore, the remote signal input system of an embodiment can input location signals into the display device at the position far from the display device.

In addition, since the modulated laser is used as the signal light, the signal light may not interfere with external light and/or backlight.

Further, if a visible ray is used as the signal light, the user can visually detect the location of the signal input into the display device.

### BRIEF DESCRIPTION OF THE DRAWINGS

FIG. 1 is a perspective view showing a remote signal input system according to an embodiment;

FIG. 2 is a circuit view showing a transmitting device according to an embodiment;

FIG. 3 is a view showing a waveform of a modulated laser;

FIG. 4 is a plan view showing pixels of a display device according to an embodiment;

FIG. 5 is a circuit view showing a part of a display panel according to an embodiment;

FIG. 6 is a sectional view of a display panel according to an embodiment;

FIG. 7 is a circuit view showing a transmitting device according to another embodiment;

FIG. 8 is a plan view showing pixels of a display device according to another embodiment; and

FIG. 9 is a sectional view of a display panel according to another embodiment.

### DETAILED DESCRIPTION OF THE EMBODIMENTS

In the description of an embodiment, it will be understood that when a panel, a member, a part, a plate or a substrate is referred to being “on” or “under” another panel, another member, another part, another plate or another substrate, it can be “directly” or “indirectly” on the other panel, member, part, plate or substrate, or one or more intervening panels, members, parts, plates or substrates may be also be present. Further, the meaning of “on” or “region” must be determined based on the accompanying drawings. The thickness and size of some components shown in the drawings can be exaggerated, In addition, the size of each component does not utterly reflect an actual size.

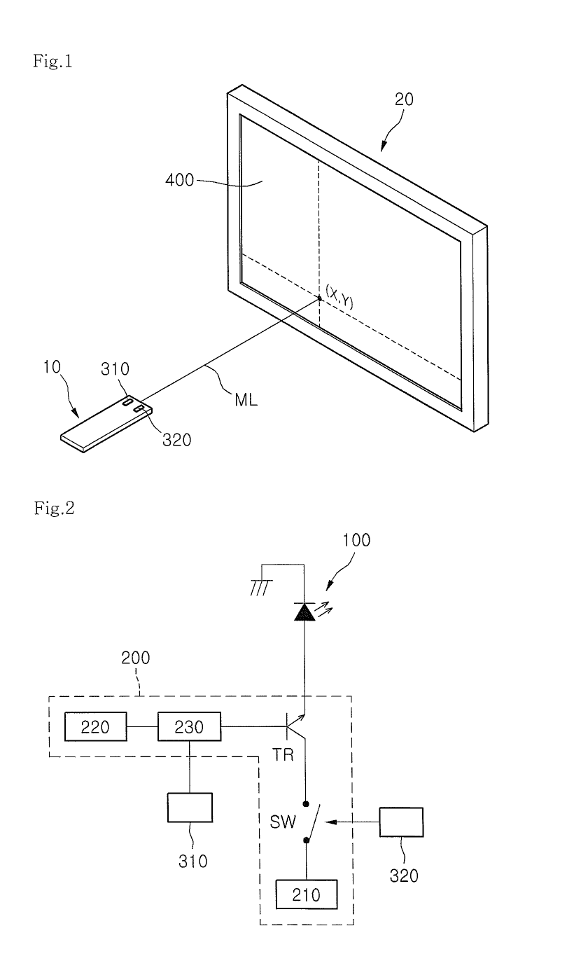

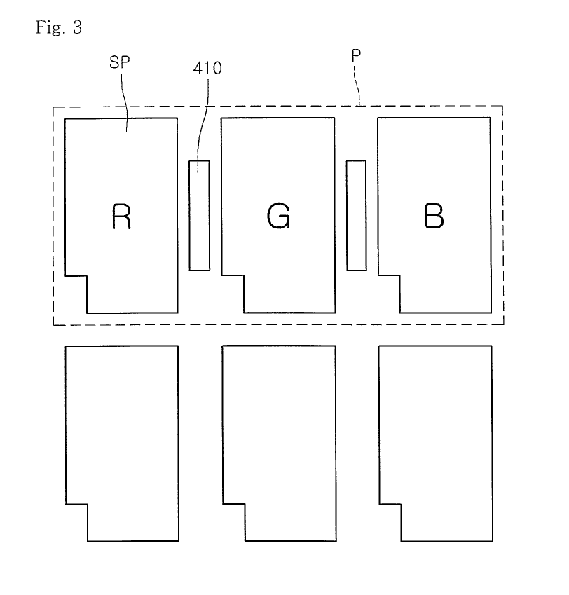

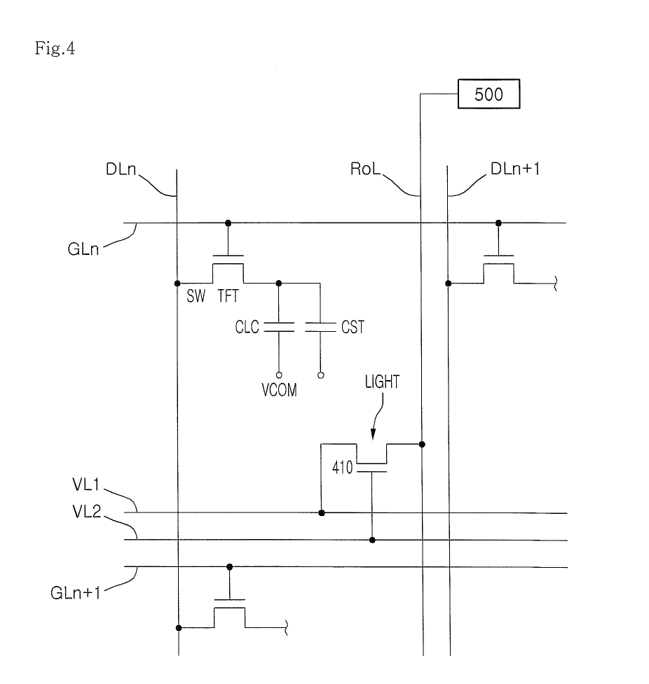

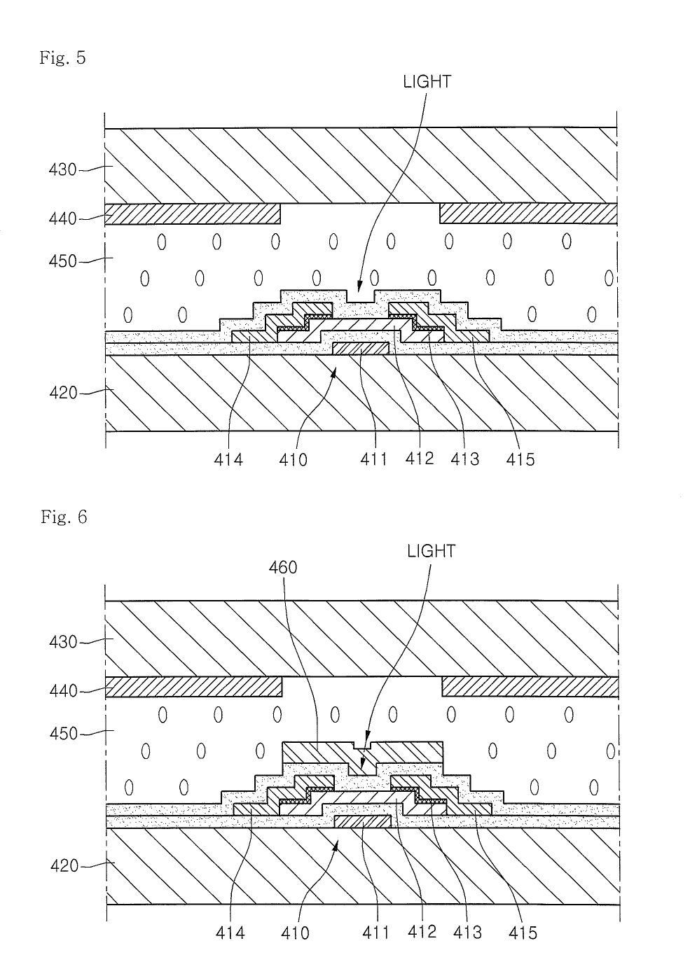

FIG. 1 is a perspective view showing a remote signal input system according to an embodiment, FIG. 2 is a circuit view showing a transmitting device according to an embodiment, FIG. 3 is a view showing a waveform of a modulated laser, FIG. 4 is a plan view showing pixels of a display device according to an embodiment, FIG. 5 is a circuit view showing a part of a display panel according to an embodiment, and FIG. 6 is a sectional view of the display panel according to an embodiment.

Referring to FIG. 1, the remote signal input system includes the transmitting device 10 and the display device 20.

Signal light is output from the transmitting device 10 and then input into the display panel 400. The display device 20 senses the signal light to detect the location of the signal light input into the display device 20. The signal light includes a modulated laser ML.

Referring to FIG. 2, the transmitting device 10 includes a laser diode 100, a driving unit 200, a first button 310 and a second button 320.

The laser diode 100 generates visible laser and is driven by the driving unit 200.

The driving unit 200 operates the laser diode 100. The driving unit 200 includes a power source 210, an oscillator 220, a driver 230, a switching device SW and a transistor TR.

The power source 210 supplies power to the laser diode 100. In more detail, the power source 210 selectively supplies the power to the laser diode 100 through the switching device SW and the transistor TR.

The oscillator 220 generates a clock signal having a predetermined frequency. The clock signal is supplied to the driver 230.

The driver 230 generates a driving signal based on the clock signal in order to drive the transistor TR. The driver 230 is turned on or off according to the signal which is applied thereto through the first button 310.

The switching device SW is turned on or off according to the signal applied thereto through the second button 320 . If the switching device SW is turned off, the laser diode 120 is turned off. Thus, the laser diode 100 does not generate the laser.

The transistor TR is rapidly and repeatedly turned on and off according to the driving signal applied thereto from the driver 230. The laser diode 100 is rapidly turned on and off according to the operation of the transistor TR, thereby generating the modulated laser ML having a predetermined frequency.

At this time, the modulated laser ML may have the frequency of about 10 to 20 MHz.

As the user operates the first button 310, the driver 230 is turned on or off. In addition, the switching device SW is turned on or off as the user operates the second button 320.

That is, if the driver 230 is turned on through the operation of the first button 310, the driver 230 rapidly and repeatedly turns on and off the transistor TR. Therefore, the laser diode 100 generates the modulated laser ML.

Referring to FIG. 3, for example, the modulated laser ML may have a repeated waveform obtained by lasers having intensity of zero and lasers having predetermined intensity.

The transmitting device 10 generates the modulated laser ML according to the operation of the first button 310.

In addition, when the switching device SW is turned on through the operation of the second button 320, the power is supplied to the laser diode 100. However, if the switching device SW is turned off, the power is not supplied to the laser diode 100 regardless of the operation of the driver 230.

The transmitting device 10 generates the laser according to the operation of the second button 320.

The display device 20 displays an image and receives the signal from the transmitting device 10 through the screen on which the image is displayed. In detail, the display device 20 receives the signal light, which is output from the transmitting device 10, through the screen.

In more detail, the display device receives the modulated laser ML, which is output from the transmitting device 10, through the screen.

The display device 20 includes the display panel 400 and a detection unit 500. In addition, the display device 20 may further include devices for driving the display panel 400.

Referring to FIG. 4, the display panel 400 displays the image and is provided therein with sensors 410 for sensing the modulated laser ML. The display panel 400 has a plate shape. The display panel 400 includes a plurality of pixels P, in which each pixel has three sub-pixels SP.

Two sensors 410 may be arranged in one pixel. In addition, one or two sensors 410 may be arranged corresponding to a plurality of pixels. That is, the sensors 410 can be arranged in some of pixels P.

The sensors 410 may include a photodiode or a photo TFT, which generates current upon receiving the light.

Referring to FIGS. 5 and 6, the display panel 400 includes a top substrate 420, a bottom substrate 430, a liquid crystal layer 450, a gate line GLn, a data line DLn, a switching thin film transistor (hereinafter, referred to as SW TFT), pixel and common electrodes CLC, a first voltage line VL1, a second voltage line VL2, a readout line RoL, and a photo thin film transistor 410 (hereinafter, referred to as photo TFT).

The top and bottom substrates 420 and 430 are aligned in opposition to each other and include transparent insulating material. For instance, glass, quartz or plastic can be used for the top and bottom substrates 420 and 430.

The liquid crystal layer 450 is interposed between the top substrate 420 and the bottom substrate 430. The liquid crystal layer 450 is aligned according to the electric field, which is generated between the pixel and common electrodes CLC, in order to adjust intensity of light passing through the liquid crystal layer 450.

The gate line GLn is interposed between the top substrate 420 and the bottom substrate 430. In more detail, the gate line GLn is aligned on the bottom substrate 430. Plural gate lines GLn extend in the first direction in parallel to each other. The signal of a gate 411 is applied to the SW TFT through the gate lines GLn to switch the SW TFT.

The data line DLn crosses the gate line GLn. Plural data lines DLn extend in the second direction in parallel to each other. The data signal is applied to the pixel electrode through the data lines DLn according to the operation of the SW TFT.

The SW TFT is aligned on a region where the data line DLn crosses the gate line GLn. The SW TFT is turned on or off according to the signal of the gate 411. Therefore, the SW TFT selectively applies the data signal to the pixel electrode.

The pixel and common electrodes CLC are interposed between the top substrate 420 and the bottom substrate 430. The pixel and common electrodes CLC generate the electric field by using the data signal and the common electrode VCOM. The liquid crystal layer 450 is aligned according to the electric field.

The first voltage line VL1 is interposed between the top substrate 420 and the bottom substrate 430. Plural first voltage lines VL1 extend in parallel to each other. The first voltage lines VL1 supply bias voltage to the photo TFT 410.

The first voltage lines VL1 are aligned in parallel to the gate lines GLn on the same layer. That is, the first voltage lines VL1 can be formed simultaneously with the gate lines GLn.

The second voltage line VL2 extends in parallel to the first voltage line VL1 in order to supply external off-level voltage to the photo TFT 410.

The photo TFT 410 is formed at the region defined by the first voltage line VL1 and the second voltage line VL2. In more detail, the photo TFT 410 is formed at the region where the first voltage line VL1 crosses the second voltage line VL2.

The photo TFT 410 includes a source 414, a drain 415, an active layer 412, and the gate 411. In addition, an ohmic contact layer 413 is formed between the active layer 412 and the source 414 and between the active layer 412 and the drain 415.

The source 414 is connected to the first voltage line VL1 and the drain 415 is connected to the readout line RoL. In addition, the source 414 is spaced apart from the drain 415.

The active layer 412 is aligned below the source 414 and the drain 415. The gate 411 is aligned below the active layer 412 and is connected to the second voltage line VL2.

As the external light is incident into the active layer 412, the photo TFT 410 supplies photo current to the readout line RoL through the drain 415. The photo current is a kind of photo detecting signals and serves as information for detecting the location X and Y.

The readout line RoL extends in the second direction and outputs the photo detection signal, which is output through the drain 415, to the detection unit 500.

Off-level voltage is applied to the gate 411, and bias voltage having a predetermined level is applied to the source 414. In addition, as the external light is applied to the active layer 412, the photo detection signal is output through the drain 415.

The bias voltage is used for detecting the photo current flowing through the active layer 412 formed in a predetermined pixel P.

For instance, if the external light is not applied to the active layer 412, the photo current is not generated through the active layer 412 even if the bias voltage is applied to the source 414.

However, in a state in which the external light is being applied to the active layer 412, if the bias voltage is applied to the source 414, the photo current is generated through the active layer 412. Thus, the readout line RoL is charged so that voltage variation may occur. In addition, the photo detection signal is output to the detection unit 500 connected to a terminal of the readout line RoL.

The photo TFT 410 can sense the signal irradiated from the transmitting device 10, that is, the modulated laser ML. In other words, the photo TFT 410 is a sensor that detects the modulated laser ML.

The detection unit 500 receives the photo detection signal from the readout line RoL and analyzes the photo detection signal. In addition, the detection unit 500 detects the photo detection signal (hereinafter, referred to as input signal) formed by the modulated laser ML.

The input signal has a frequency corresponding to the frequency of the modulated laser ML, and the detection unit 500 detects the input signal by analyzing the frequency of the photo detection signal.

In addition, the detection unit 500 can analyze the location X and Y of the photo TFTs 410, which are aligned corresponding to the region to which the modulated laser is irradiated, by detecting the input signal.

The input signal is a signal transmitted from the transmitting device 10 to the display device 20. At this time, the detecting unit 500 detects the input signal in the photo detection signal.

Therefore, the detection unit 500 can detect the location X and Y to which the modulated laser ML is irradiated.

Hereinafter, the signal input procedure in the remote signal input system of the embodiment will be described.

First, the user operates the second button 320 to turn on the switching device SW. Thus, the laser diode 100 generates the laser. In detail, the laser diode 100 generates the visible laser.

Then, the transmitting device 10 irradiates the laser to the predetermined location X and Y of the screen. Since the laser diode 100 generates the visible laser, the user can visually detect the location X and Y to which the laser is irradiated.

Next, the user operates the first button 310 to turn on the driver 230. Thus, the laser diode 100 generates the modulated laser ML.

The sensors 410, that is, the photo TFTs 410 sense the modulated laser ML and input the input signal to the detection unit 500.

The detection unit 500 can detect the location of the modulated laser ML by analyzing the input signal.

Therefore, the user can input the signal into the desired location X and Y of the display device 20 by using the transmitting device 10 at the position far from the display device 20.

In addition, since the remote signal input system of the embodiment uses the modulated laser ML, malfunction caused by external light or backlight can be prevented.

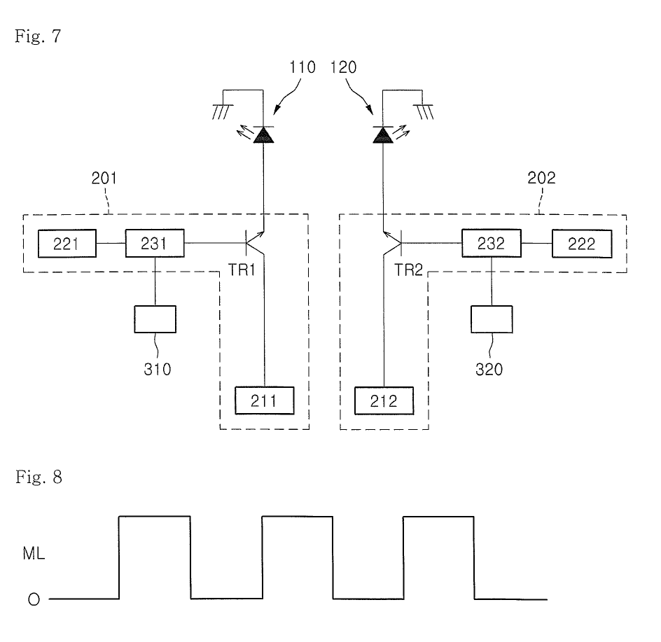

FIG. 7 is a circuit view showing a transmitting device according to another embodiment, and FIG. 8 is a plan view showing pixels of a display device according to another embodiment. In this embodiment, description will be made while focusing on the transmitting device and sensors, and elements and structures described in the previous embodiment will not be further described in order to avoid redundancy.

Referring to FIG. 7, the transmitting device 10 includes a first laser diode 110, a second laser diode 120, a first driving unit 201, a second driving unit 202, a first button 310 and a second button 320.

The first laser diode 110 generates the infrared laser, and the second laser diode 120 generates the visible laser.

The first driving unit 201 drives the first laser diode 110, and the second driving unit 202 drives the second laser diode 120.

The first driving unit 201 includes a first power source 211 that supplies power to the first laser diode 110, a first oscillator 221 that generates a first clock signal having a predetermined frequency, and a first driver 231 that drives a first transistor TR1 based on the first clock signal. The first transistor TR1 is repeatedly turned on and off by the first driver 231.

The first driving unit 201 is turned on or off according to the operation of the first button 310. In detail, the first driver 231 is turned on or off according to the operation of the first button 310.

The second driving unit 202 includes a second power source 212 that supplies power to the second laser diode 120, a second oscillator 222 that generates a second clock signal having a predetermined frequency, and a second driver 232 that drives a second transistor TR2 based on the first clock signal. The second transistor TR2 is repeatedly turned on and off by the second driver 232.

The first power source 211 may be identical to the second power source 212, and the first oscillator 221 may be identical to the second oscillator 222.

The second driving unit 202 is turned on or off according to the operation of the second button 312. In detail, the second driver 232 is turned on or off according to the operation of the second button 320.

The transmitting device 10 can generate the modulated visible laser and modulated infrared laser.

Referring to FIG. 8, the display panel 400 includes a first sensor 411 and a second sensor 412. The first sensor 411 senses the light of visible ray band, and the second sensor 412 senses the light of infrared ray band.

That is, the first sensor 411 senses the modulated visible laser and the second sensor 412 senses the modulated infrared laser.

The first and second sensors 411 and 412 can be aligned in one pixel P in correspondence with each other.

The first input signal, which is generated from the first sensor 411 based on the modulated visible laser, and the second input signal, which is generated from the second sensor 412 based on the modulated infrared laser, are input into the detection unit 500.

The detection unit 500 can detect the position of the sensors by analyzing the first and second input signals.

Therefore, the remote signal input system according to the embodiment can simultaneously input two signals or more to the display device 20.

For instance, the remote signal input system can input the location signal to the display device 20 by using the modulated visible laser, and can input the control signal to the display device 20 by using the modulated infrared signal to control the display device 20.

According to this embodiment, the modulated visible laser and the modulated infrared laser are used as signal lights. In addition, modulated lasers having frequencies different from each other can be used as signal lights.

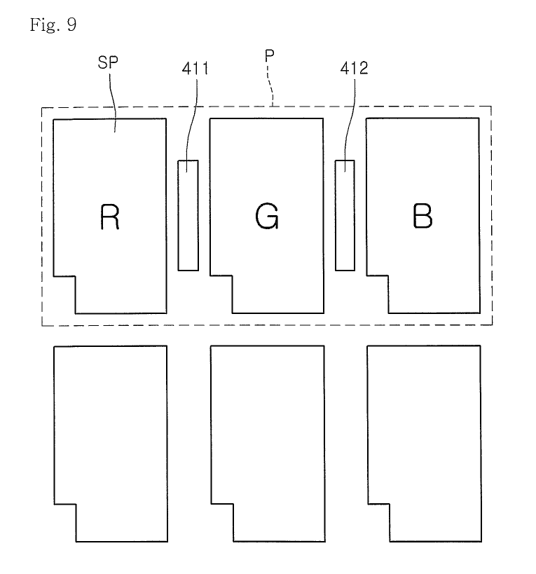

FIG. 9 is a sectional view of a display panel according to another embodiment.

In this embodiment, description will be made while focusing on an infrared band pass filter, and elements and structures described in the previous embodiment will not be further described in order to avoid redundancy.

The infrared band pass filter (hereinafter, referred to as IR filter) 460 is installed in the display panel. In detail, the IR filter 460 is installed on the sensor. In more detail, the IR filter 460 is installed on the photo TFT 410. That is, the IR filter 460 is aligned corresponding to the photo TFT 410.

The IR filter 460 filters the light passing therethrough such that only the light having the infrared band can pass through the IR filter 460. The IR filter 460 may include calcium fluoride (CaF₂) or alumina (Al₂O₃).

Thus, among lasers irradiated from the transmitting device 10, the laser having the visible ray band may be filtered by the IR filter 460 and the laser having the infrared band may pass through the IR filter 460.

That is, the laser having the visible ray band can be sensed by using infrared sensors.

Therefore, the display device 20 according to the embodiment can sense the visible laser and infrared laser by using the infrared sensors.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A remote signal input system comprising:
a transmitting device for generating signal light; and
a display panel comprising a plurality of sensors for sensing the signal light.

2. The remote signal input system of claim 1, wherein the signal light comprises a modulated laser.

3. The remote signal input system of claim 1, wherein the transmitting device generates first and second signal lights.

4. The remote signal input system of claim 3, wherein the first signal light is a modulated visible laser, and the second signal light is a modulated infrared laser.

5. The remote signal input system of claim 1, wherein the display panel comprises:
a plurality of power lines aligned in a first direction; and
a plurality of readout lines crossing the power lines, wherein the sensors are disposed at regions where the readout lines cross the power lines.

6. A display device comprising:
a display panel comprising a plurality of sensors for sensing signal light generated from a transmitting device; and
a detection unit that receives sensing signals output from the sensors to detect signals transmitted from the transmitting device.

7. The display device of claim 6, wherein the display panel comprises:
a plurality of power lines aligned in parallel to each other to supply power to the sensors, respectively; and
a plurality of output lines that transmit signals from the sensors and cross the power lines.

8. The display device of claim 6, wherein the signal light comprises a modulated laser.

9. The display device of claim 8, wherein the sensing signal has a frequency corresponding to a modulation frequency of the signal light.

10. The display device of claim 6, wherein the signal light comprises a first signal light and a second signal light, the first signal light has a main wavelength band different from a main wavelength band of the second signal light, and the sensors comprise a first sensor for sensing the first signal light and a second sensor for sensing the second signal light.

11. The display device of claim 10, wherein the first signal light is a visible laser and the second signal light is an infrared laser.

12. The display device of claim 6, further comprising a filter installed on the sensor to allow light having a predetermined wavelength band to pass therethrough.

13. A transmitting device comprising:
a light source for generating signal light; and
a driving unit that drives the light source to generate the signal light.

14. The transmitting device of claim 13, wherein the light source comprises a laser diode and the signal light comprises a modulated laser.

15. The transmitting device of claim 14, wherein the light source comprises a first light source for generating a visible laser and a second light source for generating an infrared laser.

16. The transmitting device of claim 14, wherein the driving unit drives the light source such that the modulated laser is selectively generated.
